(19) United States
(12) Patent Application Publication
(10) Pub. No.: US 2015/0011345 A1
(43) Pub. Date: Jan. 8, 2015

(54) TENSIONING DEVICE FOR A TRACTION MEMBER, ENGINE EQUIPPED WITH SUCH A TENSIONING DEVICE AND METHOD FOR IMPLEMENTING SAME

(71) Applicant: Aktiebolaget SKF, Göteborg (SE)

(72) Inventors: Romuald Lescorail, St. Laurent en Gâtines (FR); Nicolas Tronquoy, Fondettes (FR)

(21) Appl. No.: 14/322,171

(22) Filed: Jul. 2, 2014

(30) Foreign Application Priority Data
Jul. 2, 2013 (FR) 1356456

(51) Int. Cl. F16H 7/12

(52) U.S. Cl. CPC F16H 7/12
USPC 474/136

(57) ABSTRACT

The present invention relates to a tensioning device having a mounting plate; a tensioning roller centered on a roller axis and mounted movably on the plate, with at least one degree of rotational freedom around a pivot axis that is off-centered relative to the roller axis between at least one initial configuration, a mounting configuration and a final configuration for tensioning the traction member positioned on the tensioning roller. The device includes means for locking the tensioning roller relative to the mounting plate in the different configurations of the tensioning device. The tensioning device has at least partially removable means for indexing the position of the tensioning roller relative to the mounting plate in the final configuration. The invention also relates to an engine equipped with at least one traction member and at least one tensioning device. The invention also relates to a method for implementing such a tensioning device.

### CROSS-REFERENCE TO RELATED APPLICATIONS

This application claims priority to French Patent Application No. 1356456 filed Jul. 2, 2013, the contents of which are herein fully incorporated by reference.

### FIELD OF THE INVENTION

The present invention relates to a tensioning device for a traction member, for example a belt or chain equipping the internal combustion engine of a motor vehicle. The invention also relates to an engine equipped with such a tensioning device, as well as a method for implementing such a tensioning device. The invention relates to the field of tensioning devices.

### BACKGROUND OF THE INVENTION

Traditionally, such a tensioning device is used to apply a constant tension on the traction member in a predetermined tension range and/or to locally modify a traction circuit comprising said member. Once mounted in the traction circuit, the traction member is driven by at least one engine device, in particular by a crankshaft equipping the internal combustion engine, and drives at least the device to which it is connected and which must be set in motion, in particular a compressor or a generator.

In practice, the traction member is connected to the engine device and to the driven device by means of pulleys mounted on those devices. The traction member is next placed under tension owing to the tensioning device, at a sufficient usage tension to avoid any slippage on the pulleys and allow optimal operation of the traction circuit.

U.S.-A-2008/0207367 describes a tensioning device comprising a lever arm and a spring provided to place the traction member under tension. Initially, a pre-tension configuration is indexed by a rod passing through the lever arm and penetrating a mounting plate. Once the tensioning device is mounted on the engine, the rod is removed and the traction member is automatically placed under tension under the action of the spring. Due to the presence of the lever arm and the spring, such a tensioning device has a significant bulk and cannot be used for certain applications. Furthermore, due to the large number of parts making up the tensioning device, its cost and mounting time are relatively high. Lastly, the spring is capable of relaxing over time, thereby causing a release of the tension exerted by the tensioning device on the traction member and downgraded operation of the traction circuit.

### SUMMARY OF THE INVENTION

The aim of the present invention is to propose an improved tensioning device.

To that end, the invention relates to a tensioning device, comprising: a mounting plate; a tensioning roller centered on a roller axis and movably mounted on the mounting plate, with at least one degree of rotational freedom around a pivot axis that is off-centered relative to the roller axis between at least one initial configuration, a mounting configuration and a final configuration for tensioning the traction member positioned on the tensioning roller; and locking means for locking the tensioning roller relative to the mounting plate in the different configurations of the tensioning device. This tensioning device is characterized in that it also comprises at least partially removable indexing means for indexing the position of the tensioning roller relative to the mounting plate in the final configuration.

Thus, the invention facilitates the mounting of the traction member in the correct position, with satisfactory tension, as well as locking of the tensioning roller in position relative to the plate, reliably and securely. In the absence of any lever arm, the bulk of the tensioning device is reduced. Furthermore, the tensioning device according to the invention is easy to manufacture and practical to assemble within the traction circuit.

According to other advantageous features of the invention, considered alone or in combination:
The indexing means comprise an indexing member separate from the locking means.
The indexing means comprise an indexing member belonging to the locking means.
The indexing means comprise an indexing member including, on the one hand, a first portion remaining in the tensioning device and, on the other hand, a second portion removable relative to the first portion, in particular by breaking, in the final configuration of the tensioning device.
The indexing means comprise an indexing member remaining in the tensioning device in the final configuration.
The indexing means comprise an indexing member completely removed from the tensioning device in the final configuration, in particular by traction or unscrewing.
The indexing means comprise an indexing member including a threaded part that is screwed into the mounting plate.
The threaded part remains in the mounting plate in the final configuration of the tensioning device.
The indexing means form non-return blocking means preventing the tensioning roller from returning from the final configuration to the assembled configuration relative to the mounting plate, in particular under the action of stresses exerted by the traction member on the tensioning roller.
The indexing means comprise: a first female non-return element belonging to the mounting plate; a second female non-return element belonging to the tensioning roller; and a male non-return element partially removable in the different configurations of the tensioning device.
A screw belonging to the locking means defines the pivot axis.
The mounting plate includes a protuberance defining the pivot axis.

The invention also relates to an engine equipped with at least one traction member, characterized in that it is also equipped with at least one tensioning device as described above. Preferably, the rear plate of the tensioning device is fastened to a wall of that engine.

The invention also relates to a method for implementing a tensioning device, comprising an mounting plate for mounting on a support and a tensioning roller centered on a roller axis, the tensioning roller being movably mounted on the mounting plate with at least one degree of rotational freedom around a pivot axis that is off-centered relative to the roller axis. The method is characterized in that it comprises at least the following successive steps:
a step for providing the tensioning device comprising at least partially removable indexing means for indexing the position of the tensioning roller relative to the mounting plate in an initial configuration of the tensioning device;
a step for preparing the mounting, in which a removable member belonging to the indexing means is removed from the tensioning device;
a mounting step, in which the mounting plate is fixedly positioned on the support;
a step for preparing the tensioning, in which the removable member is manually maintained in a first orifice belonging to the indexing means and formed in the tensioning roller;
a step for tensioning a traction member, in which the tensioning roller pivots around a pivot axis, until the removable member penetrates, through manual action, into a second orifice belonging to the indexing means and formed in the mounting plate; and
a locking step, in which the rotation of the tensioning roller relative to the mounting plate around the pivot axis is locked by locking means and the traction member is kept under tension by the tensioning device.

According to one particular embodiment, the method also comprises a step for removing at least one portion of the removable member outside the tensioning device, in particular by breaking, traction or unscrewing.

### BRIEF DESCRIPTION OF THE DRAWINGS

The invention will be better understood upon reading the following description, provided solely as a non-limiting example and done in reference to the appended drawings, in which:

FIG. 1 is a front view of a tensioning device according to the invention, shown in a mounting configuration, the device comprising a removable indexing pin, not shown because it has been removed from the device during mounting;

FIG. 2 is a front view similar to FIG. 1, showing the tensioning device in a final tensioned configuration of a traction member, before partial removal of the indexing pin;

FIG. 3 is a cross-section along line III-III in FIG. 2, showing the tensioning device in an initial configuration, before removal of the pin and mounting of the traction member;

FIG. 4 is a perspective view showing the tensioning device in the initial configuration of FIG. 3;

FIG. 5 is a partial cross-section along line V-V in FIG. 2;

FIG. 6 is a cross-section similar to FIG. 4 for a tensioning device according to a second embodiment of the invention, shown in the initial configuration;

FIG. 7 is a front view similar to FIGS. 1 and 2 for a tensioning device according to a third embodiment of the invention, shown in the initial configuration;

FIG. 8 is a cross-section along line VIII-VIII in FIG. 7;

FIG. 9 is a perspective view similar to FIG. 4, showing the tensioning device of FIGS. 7 and 8.

### DETAILED DESCRIPTION OF THE INVENTION

FIGS. 1 to 5 show a tensioning device 2 according to the invention.

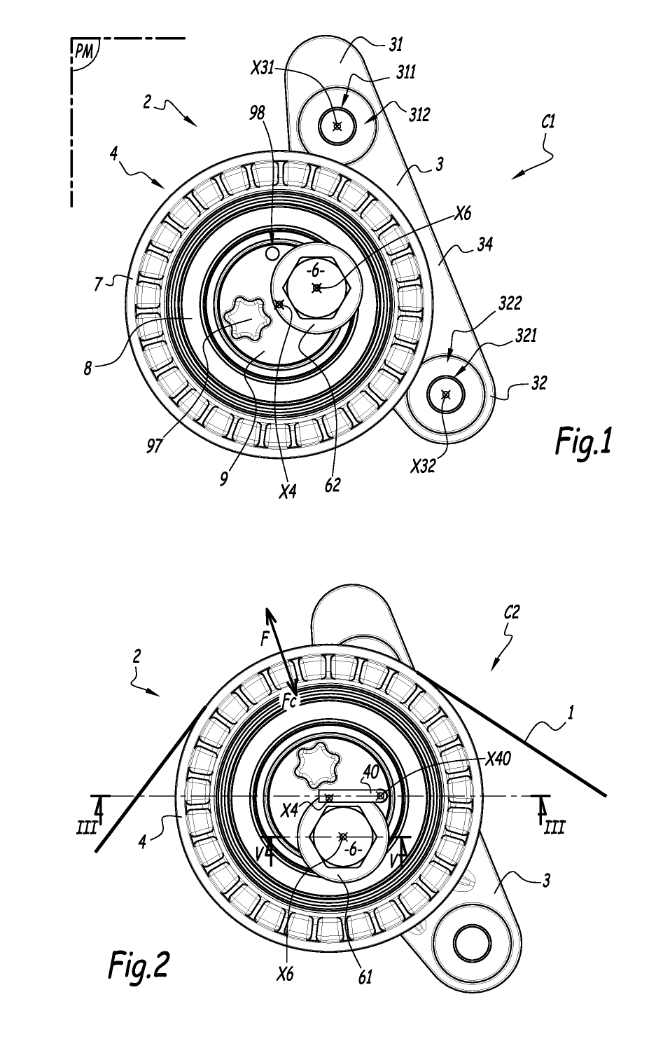

The tensioning device 2 is suitable for the controlled tensioning of a traction member 1. As one non-limiting example, this traction member 1 may be a belt or chain belonging to a traction circuit equipping an engine. For simplification purposes, the belt 1 is partially diagrammatically shown only in FIG. 2 while the engine and the other component elements of the traction circuit, such as pulleys cooperating with the belt 1 for the transmission of a movement within the traction circuit, are not shown.

The tensioning device 2 comprises a rear mounting plate 3 on a support PM, in particular an outer wall of the engine, as well as a tensioning roller 4 centered on a roller axis X4 and movably mounted on the plate 3. The wall of the engine PM is partially a diagrammatically shown by dotted lines in FIG. 1, for simplification purposes. “Rear” defines an orientation toward the wall PM, while “front” defines an orientation oriented opposite the wall PM. When the tensioning device 2 equips the engine, the rear plate 3 is situated behind and the tensioning roller 4 is situated in front of the tensioning device 2.

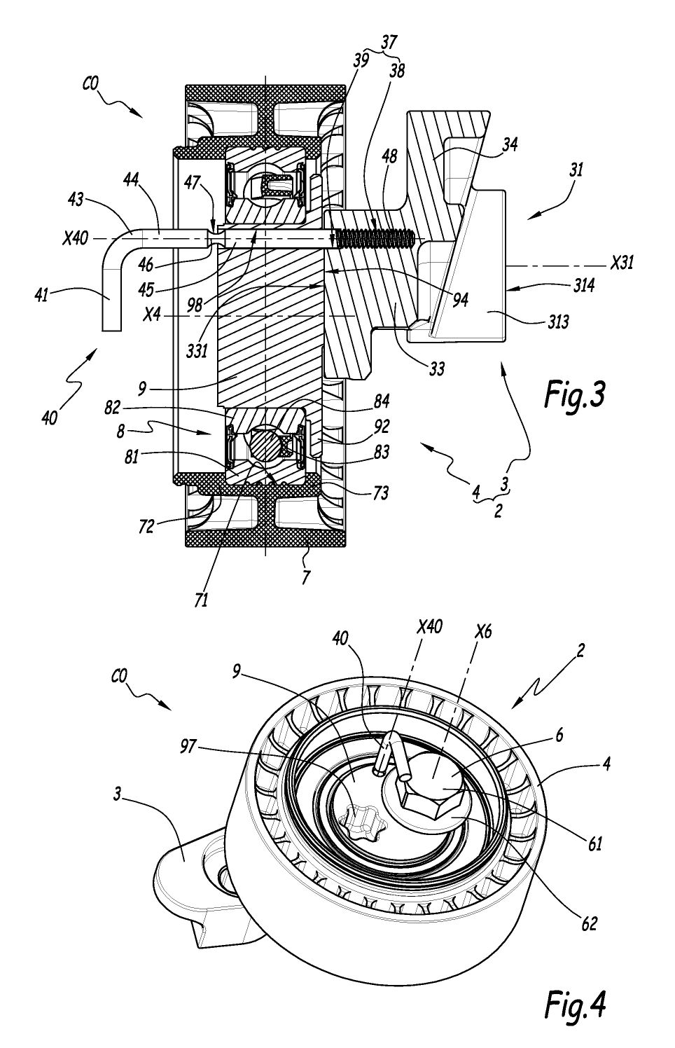

In particular, the tensioning roller 4 is movably mounted on the plate 3 with at least one degree of rotational freedom around a pivot axis that is off-centered relative to the roller axis X4, as outlined below. Due to the mobility between the rear plate 3 and the tensioning roller 4, the tensioning device 2 may assume different distinct configurations. More specifically, the tensioning device 2 has at least one initial configuration C0 referred to as the provision or delivery configuration to the operator, a configuration C1 for assembling the plate 3 on the wall of the engine PM without tensioning the belt 1, and a so-called active or final tensioning configuration C2 of the belt 1 positioned on the tensioning roller 4. In the final configuration C2, a tensioning force F is exerted in a controlled manner on that belt 1, radially to the axis X4. The mounting configuration C1 is shown in FIG. 1, the final configuration C2 is shown in FIGS. 2 to 5, and the initial configuration C0 is shown in FIGS. 3 and 4.

The rear plate 3 has a globally elongated shape between two ends 31 and 32. The plate 3 also has a support part 33 provided to receive the tensioning roller 4, as well as a central part 34 connecting the two ends 31 and 32 to the support plate 33. In a front-back direction parallel to the axis X4, the central part 34 is thinner than the ends 31 and 32 and than the support part 33.

The ends 31 and 32 are provided with two through orifices, 311 and 321, respectively, formed along two axes X31 and X32 parallel to each other and to the axis X4. These through orifices 311 and 321 are provided to receive fastening elements of the plate 3, and therefore of the tensioning device 2, on the outer wall of the engine PM. Stepped housings 312 and 322 are respectively formed around the orifices 311 and 321, on the front side of the plate 3, and form a bearing surface for those fastening elements, not shown for simplification purposes. Advantageously, the orifice 311 is oblong to facilitate the mounting of the plate 3 on the wall of the engine PM, based on the positioning allowances in that wall PM of orifices for receiving the fastening elements of the plate 3.

The ends 31 and 32 include protrusions 313 formed on the rear side of the plate 3. These protrusions 313 are provided with surfaces 314, which are planar and perpendicular to the axes X31 and X32, bearing against the wall PM. In order to improve the mechanical strength of the plate 3 in its fastening zone to the engine, the protrusions 313 are thicker than the central part 34.

To ensure optimal strength of the plate 3 at its fastening interface with the tensioning roller 4 and avoid any risk of friction of the pivoting tensioning roller 4 relative to the plate 3, the thickness of the support part 33 is greater than that of the central part 34. Thus, the support part 33 forms a protrusion on the front side of the plate 3 and is provided with a surface 331, which is planar and perpendicular to the axes X31 and X32, oriented on the front side of the plate 3 across from the tensioning roller 4. Furthermore, the support part 33 is provided with a through opening 36 with axis X36 parallel to the axes X4, X31 and X32. This opening 36 is tapped in order to receive a screw 6 for maintaining the tensioning roller 4 on the plate 3. The screw 6 extends along an axis X6 coinciding with the axis X36 and is provided with a screw head 61 positioned on the front side of the tensioning roller 4.

The tensioning roller 4 comprises a pulley 7 centered on the roller axis X4 and at the outer periphery of which the belt 1 is mounted. The pulley 7 includes a bore 71, in which a bearing 8 is positioned that is centered on the axis X4 and supports the rotation of the pulley around the axis X4. The bearing 8 includes an outer ring 81 and an inner ring 82 delimiting a bearing chamber radially to the axis X4. A bearing cage 83, provided to maintain rolling elements such as beads 84 in FIG. 3, is positioned in this chamber. Alternatively, the rolling elements may be rolls.

The pulley 7 is rigidly assembled on the outer ring 81 of the bearing 8, which is fixedly positioned in the bore 71. Two stops 72 and 73 are formed on either side of the bore 71 in a direction parallel to the axis X4. The stops 72 and 73 grip the outer ring 81 and prevent any axial movement of the pulley 7 along the axis X4 relative to the bearing 8.

The tensioning roller 4 also includes a roller support 9 centered on the roller axis X4. The roller support 9 comprises a cylinder 91 and an annular disc 92 with a diameter larger than that of the cylinder 91 radially to the axis X4. The disc 92 is situated behind the cylinder 91. The inner ring 82 of the bearing 8 includes a bore with a diameter substantially equal to that of the cylinder 91, in which the latter is assembled. Advantageously, on the front side of the tensioning roller 4, the inner ring 82 may be secured to the cylinder 91 by crimping material beads of the cylinder 91 against the inner ring 82. On the rear side of the tensioning roller 4, the annular disc 92 is in contact with the inner ring 82 and forms an additional axial stop for that ring 82.

The roller support 9 is also provided with a through opening, not shown for simplification purposes, centered on the screw axis X6 radially offset and parallel to the roller axis X4. This through opening is provided to receive the screw 6, which can next be screwed into the tapped opening formed in the plate 3 so as to keep the tensioning roller 4 in position relative to the plate 3. The roller support 9 is also provided with a rear planar surface 94 provided to come into contact with the front surface 331 of the plate 3.

The roller support 9 is also provided with a front planar surface 95, against which the screw head 61 bears when the screw 6 is screwed into the tapped opening of the plate 3. To increase its bearing surface against the surface 95, the screw head 61 can advantageously be provided with a collar 62 secured to said screw head 61. This collar 62 is not shown in FIG. 3 for simplification purposes. Alternatively, the washer 62 can be separate from the screw head 61.

Once the tensioning roller 4 is assembled on the plate 3 and the screw 6 is positioned in the openings 93 and 36, the axes X6 and X36 coincide while being parallel and off-centered radially to the roller axis X4. Thus, when the screw 6 is not gripped against the roller support 9, the tensioning roller 4 is rotatable around a pivot axis X6 defined by the screw 6, off-centered relative to its axis X4. Preferably, the tensioning roller 4 can be moved by an operator by inserting a tool into a blind housing 97 formed in the roller support 9 at the surface 95. Alternatively, the housing 97 is not blind, but passes through the roller support 9 parallel to the axis X4.

In practice, the screw 6 and the tapped opening 36 form means for locking the tensioning roller 4 relative to the plate 3, in the different configurations of the tensioning device 2, in particular configurations C0, C1 and C2.

As shown in particular in FIG. 3, the device 2 also comprises a pin 40 including a head 41 and a rod 42 connected to each other by an intermediate part 43. That part 43 of the pin 40 is bent, such that the head 41 is inclined at a right angle relative to the rod 42. The rod 42 extends along a pin axis X40. The rod 42 includes a proximal cylindrical part 44 and a distal cylindrical part 45 connected by a thin part 46 comprising an annular groove 47. At its end opposite the head 41, the rod 42 has a threaded part 48 extending the cylindrical part 45. The pin 40 can be made from plastic or metal. The thin part 46 forms a localized weak area of the rod 42, such that the parts 41, 43 and 44 can be separated from the parts 45 and 48 by a fragile break of the rod 42 in the thin part 46, once the device 2 is in the final configuration C2.

To receive the pin 40, the support 9 includes a cylindrical through orifice 98 between its surfaces 94 and 95, while the support part 33 of the plate 3 has an orifice 37 including a tapped part 38 and a cylindrical part 39. The cylindrical part 39 is situated at the mouth of the orifice 37 and emerges at the surface 331 of the plate 3. The tapped part 38 extends the cylindrical part 39 while penetrating the material of the support part 33. In an alternative that is not shown, the tapped part 38 can emerge outside the support part 33 opposite the surface 331. When the orifice 37 of the plate 3 and the orifice 98 of the roller 4 are positioned across from one another, they can receive the rod 42 in translation along the pin axis X40, then the threaded part 48 is screwed into the tapped part 38 by rotation of the pin 40 around the pin axis X40.

The method for implementing the tensioning device 2 is described below.

During a step for manufacturing the tensioning device 2, the relative position of the plate 3 and the roller 4 in the future final configuration C2 is determined The orifices 37 and 98 are then formed across from one another, in the support part 33 of the plate 3 and in the support 9 of the roller 4, respectively. As an example, the orifices 39 and 98 can be formed during a same drilling operation, then the tapped part 38 is formed during a tapping operation. The position of the orifices 37 and 98 relative to the other orifices 36, 93 and 97 accounts for the principles of mechanical strength of the materials. The pin 40 can next be positioned in the device 2.

During a provision or delivery step, corresponding to the initial configuration CO of FIGS. 3 and 4, the tensioning device 2 is delivered to the operator responsible for assembling the traction circuit. The roller 4 is locked on the plate 3 by the screw 6. The pin 40 is housed in the roller 4 and the plate 3, more specifically the rod 42 is inserted into the orifices 37 and 98. The threaded part 48 is screwed into the tapped part 38, which makes it possible to avoid accidental removal of the pin 40 outside the device 2. The pin 40 and the orifices 37 and 98 form means for indexing the position of the roller 4 relative to the plate 3 in the initial configuration C0. In this stage, the orifice 311 is not accessible to the operator from the front of the device 2, such that the plate 3 cannot be assembled on the wall PM.

During a preparation step for the mounting, the operator manually removes the pin 40 from the device 2. He unscrews the rod 42 outside the plate 3, then removes it from the roller 4 by simple traction. He also unscrews the screw 6, such that the roller 4 is freely movable around the axis X6. The orifices 311 and 321 of the plate 3 are then accessible to the operator from the front of the device 2, thereby allowing the mounting of the plate 3 on the wall PM.

During a mounting step, corresponding to the configuration C1 of FIG. 1, the mounting plate 3 is fixedly positioned on the wall PM. The orifices 311 and 321 receive elements for fastening the plate 3, and therefore the tensioning device 2, on the wall PM.

During a tensioning preparation step, the operator manually keeps the pin 40 in the orifice 98 formed in the support 9 and exerts controlled pressure toward the plate 3.

During a tensioning step of traction member 1, the tensioning roller 4 pivots around a pivot axis X6, until the pin 40 penetrates the part 39 of the orifice 37 formed in the plate 3, through manual action by the operator. In that stage, the operator knows that the position of the roller 4 corresponding to the final configuration C2 has been reached, with satisfactory tension of the traction member 1. In other words, the pin 40 and the orifices 37 and 98 form means for indexing the position of the roller 4 relative to the plate 3 in the final configuration C2, corresponding to the initial configuration C0. The operator screws the threaded part 48 of the rod 42 into the top part 38 of the orifice 37, preferably until the thin part 46 is positioned at the front surface 95 of the support 9.

At this stage, the indexing means 37, 40 and 98 form non-return blocking means preventing the tensioning roller 4 from returning from the final configuration C2 to the mounting configuration C1 relative to the mounting plate 3. The orifices 37 and 98 each make up a female non-return element, belonging to the plate 3 and the roller 8, respectively, while the pin 40 forms a removable male non-return element. These non-return blocking means 37, 40 and 98 mechanically cooperate in the final configuration C2 while preventing the roller 4 from returning to the mounting configuration C1, in particular under the action of stresses exerted by the traction member 1 on the roller 4. These stresses are diagrammatically shown by an arrow Fc opposite the arrow F in FIG. 2.

During a locking step, the tensioning device 2 is locked in the final configuration C2, while the traction member 1 is kept tensioned by the device 2. The rotation of the roller 4 relative to the plate 3 around the pivot axis X6 is locked by the tightening of the screw 6 in the tapped opening 36. To that end, the operator exerts a given torque on the screw head 61 using a tightening tool, for example a torque wrench.

During a removal step, a portion of the pin 40 is removed outside the tensioning device 2 in the final configuration C2. The thin part 46 of the rod 42, which is preferably situated at the front surface 95 of the support 9, is broken by the operator. Based on the materials and dimensions of the pin 40, this break may be fragile or ductile, manual or done using a tool, for example cutting pliers. The pin portion 40 comprising the parts 41, 43 and 44 is removed from the device 2, while the pin portion 40 comprising the parts 45 and 48 remains in the device 2, more specifically in the orifices 37 and 98. The pin 40 no longer protrudes toward the front of the roller 4.

In the final configuration C2, the action of stresses Fc exerted by the belt 1 on the tensioning roller 4 may tend to unlock the locking means 6 and 36, and thus to cause the tensioning roller 4 to return from the final configuration C2 to the mounting configuration C1 or further. In that case, the tension of the belt 1 and the operation of the traction circuit may no longer be satisfactory.

The invention makes it possible to resolve this drawback owing to the pin 40, which, even incomplete, prevents the roller 4 from returning to the mounting configuration C1. In other words, the indexing means 37, 40 and 98 form non-return blocking means complementary to the locking means 6 and 36 in the final configuration C2, which improves the performance of the tensioning device 2 over time. Compared with the existing devices with which the tension exerted on the traction member risks being released over time, for example, the devices incorporating springs or cylinders, the non-return blocking means prevent the tensioning roller from leaving the final configuration C2.

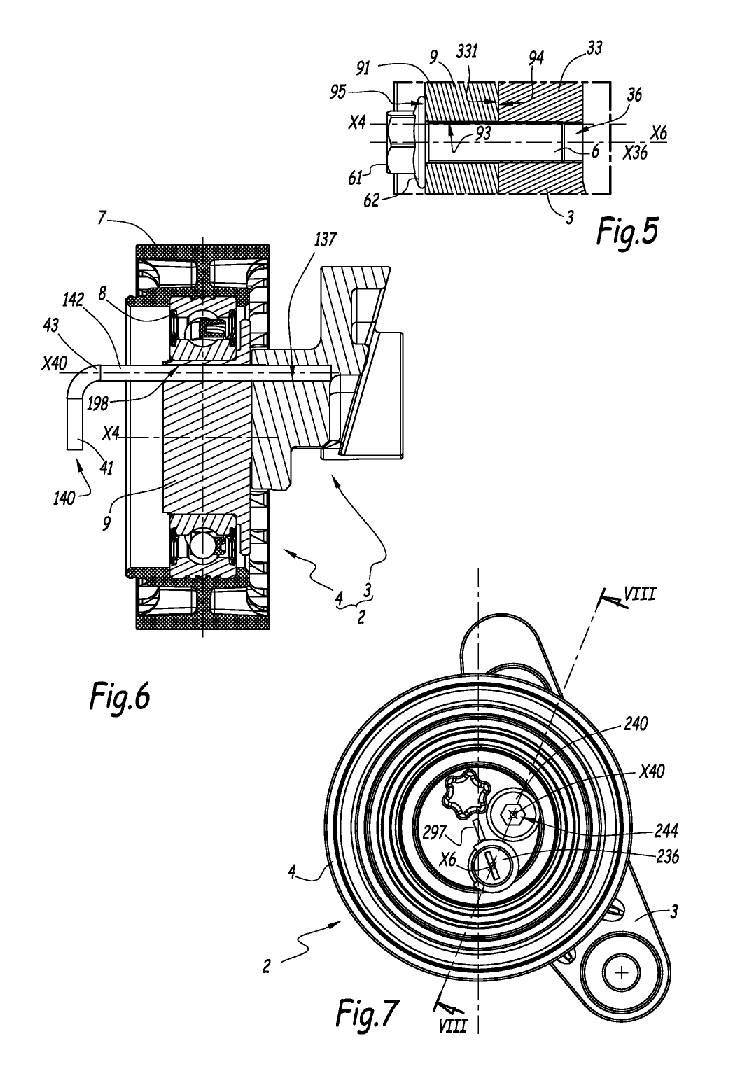

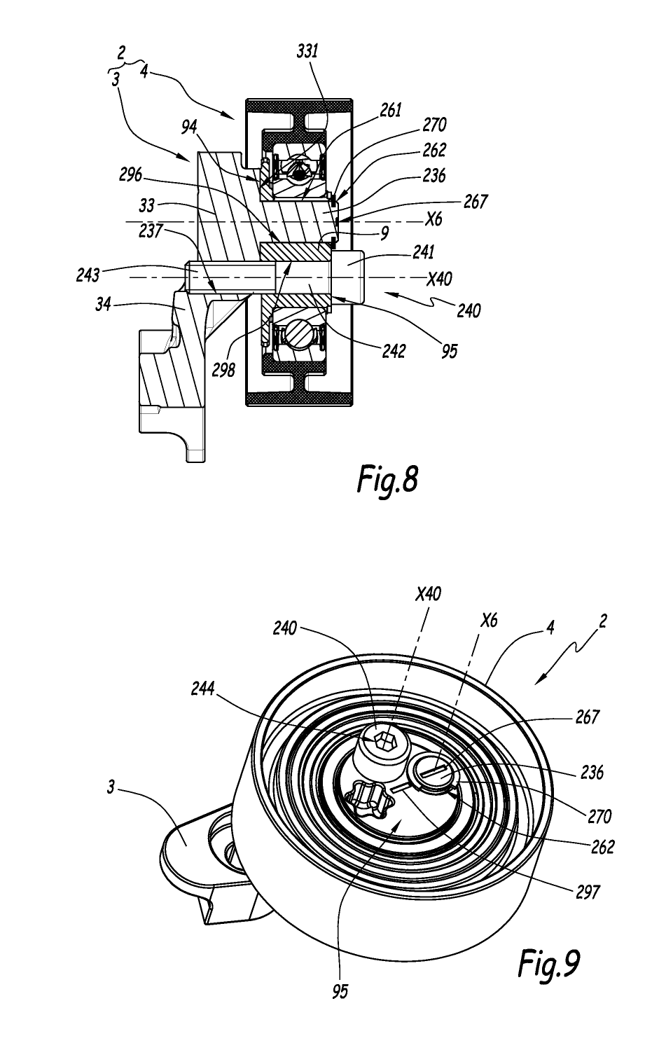

FIGS. 5 to 9 show other embodiments of a tensioning device 2 according to the invention. Some elements are similar to the component elements of the first embodiment, described above, and bear the same numerical references. Only the differences with respect to the first embodiment are described below for simplification purposes.

FIG. 6 shows the second embodiment of the tensioning device 2, including a pin 140.

In the case at hand, the pin 140 has a structure and operation that are slightly different from the pin 40 of the first embodiment. The pin 140 has a completely smooth rod 142 that extends along the pin axis 40. The plate 3 and the roller 4 therefore include orifices 137 and 198 that are both completely cylindrical. After tightening the screw 6 to lock the roller 4 in the final configuration C2, the pin 140 is fully removed from the device 2, by simple manual traction by the operator.

Alternatively, the pin 140 can include a threaded part and the orifice 137 can include a tapped part. In the final configuration C2, the pin 140 is removed from the device 2 by simple unscrewing, then manual traction by the operator.

According to another alternative, the pin 140 can include a thin part similar to the part 46 of the pin 40. In the final configuration C2, the pin 140 can be broken at the thin part, one pin portion 140 is removed from the device 2, while another pin portion 40 remains in the device 2.

FIGS. 7 to 9 show the third embodiment of the tensioning device 2, including an indexing screw 240 and a protuberance 236.

In the case at hand, the screw 240 has a different structure and operation from the pins 40 and 140 of the first embodiments. The screw 240 comprises a head 241 and a body 242 that extend along the a screw axis X40 and include a threaded part 243. The head 241 includes a housing 244 provided to receive a tool for tightening and loosening the screw 240. The housing 244 has a hexagonal section in the example of FIGS. 7 to 9. Nevertheless, as an alternative, this housing 244 may have any shape suitable for receiving a tightening tool.

The plate 3 includes a tapped orifice 237 passing through the support part 33 between its front surface 331 and the back of the plate 3. The roller 4 includes a cylindrical orifice 298 passing through the support 9 between its front surface 95 and its rear surface 94. The orifices 237 and 298 are provided to receive the body 242 of the screw 240, similarly to the orifices 37 and 98 receiving the rod 42 of the pin 40. The threaded part 243 can be screwed to the tapped orifice 237, in the initial configuration CO or the final configuration C2. The screw 240 belongs both to the indexing means and the locking means, unlike the indexing means 40 and 140 that are separate from the locking means 6 and 36. The screw 240 remains in the device 2 in the final configuration C2.

The protuberance 236 defines the pivot axis X6, instead of the screw 6 of the previous embodiments. The protuberance 236 protrudes along the axis X6 from the front surface 331 of the support part 33 of the plate 3. In other words, the member 236 is secured to the plate 3. Preferably, the protuberance 236 is integral with the support part 33 of the plate 33, for example both being formed in a single piece by molding, then the cylindrical surface 261 of the protuberance 236 is delimited by machining Alternatively, the protuberance 236 can be a separate part attached on the plate 3, for example screwed into a dedicated opening of the support part 33 of the plate 3.

The protuberance 236 includes a cylindrical outer surface 261 centered on the axis X6. The surface 261 of the protuberance 236 is adjusted in a cylindrical opening 296 formed in the support 9 of the roller 4. The protuberance 236 protrudes at the front surface 95 of the support 9. The protuberance 236 includes a slot 262 that is formed in the surface 261 and provided to receive a circlips 270. The circlips 270 bears against the surface 95 and prevents the separation of the support 9 and the protuberance 236 along the axis X6. The roller 4 is rotatable around the axis X6.

The protuberance 236 includes a slot 267 on its front face, while the surface 95 includes a slot 297. The slots 267 and 297 are elongated. When the tensioning device 2 is in configuration C0 and C2, the slots 267 and 297 are aligned, which facilitates the identification of those configurations C0 and C2.

Furthermore, the tensioning device 2 may be configured differently from FIGS. 1 to 9 without going beyond the scope of the invention.

Additionally, the technical features of the different embodiments and alternatives described below may be combined with each other in whole or in part. Thus, the tensioning device may be adapted in terms of cost, functionality and performance.

1. A tensioning device, comprising:
a mounting plate;
a tensioning roller centered on a roller axis (X4) and movably mounted on the mounting plate with at least one degree of rotational freedom around a pivot axis (X6) that is off-centered relative to the roller axis (X4) between at least one initial configuration (C0), a mounting configuration (C1) and a final configuration (C2) for tensioning (F) a traction member positioned on the tensioning roller; and
locking means for locking the tensioning roller relative to the mounting plate in the different configurations of the tensioning device; wherein
the tensioning device provides at least partially removable indexing means for indexing the position of the tensioning roller relative to the mounting plate in the final configuration (C2).

2. The tensioning device according to claim 1, wherein the indexing means includes an indexing member distinct from the locking means.

3. The tensioning device according to claim 1, wherein the indexing means includes an indexing member integral with the locking means.

4. The tensioning device according to one of claim 1, wherein the indexing means includes an indexing member having a first portion remaining in the tensioning device and a second portion removable relative to the first portion by being broken away in the final configuration (C2) of the tensioning device.

5. The tensioning device according to claim 1, wherein the indexing means includes an indexing member that remains in the tensioning device in the final configuration (C2).

6. The tensioning device according to claim 1, wherein the indexing means includes an indexing member completely removed from the tensioning device by at least one of traction and unscrewing in the final configuration (C2).

7. The tensioning device according to claim 1, wherein the indexing means includes an indexing member having a threaded part that is screwed into the mounting plate.

8. The tensioning device according to claim 1, wherein the indexing means form non-return blocking means preventing the tensioning roller from returning from the final configuration (C2) to the assembled configuration (C1) relative to the mounting plate (3) under the action of stresses (Fc) exerted by the traction member (1) on the tensioning roller (4).

9. The tensioning device according to claim 8, wherein the indexing means comprises:
a first female non-return element integral with the mounting plate;
a second female non-return element integral with the tensioning roller;
a male non-return element at least partially removable in multiple configurations of the tensioning device.

10. The tensioning device according to claim 1, further comprising a screw integral with the locking means defines the pivot axis (X6).

11. The tensioning device according to claim 1, wherein the mounting plate includes a protuberance defining the pivot axis (X6).

12. An engine equipped with at least one traction member having at least one tensioning device, the tensioning device comprising:
a mounting plate;
a tensioning roller centered on a roller axis (X4) and movably mounted on the mounting plate with at least one degree of rotational freedom around a pivot axis (X6) that is off-centered relative to the roller axis (X4) between at least one initial configuration (C0), a mounting configuration (C1) and a final configuration (C2) for tensioning (F) a traction member positioned on the tensioning roller; and
locking means for locking the tensioning roller relative to the mounting plate in the different configurations of the tensioning device; wherein
the tensioning device provides at least partially removable indexing means for indexing the position of the tensioning roller relative to the mounting plate in the final configuration (C2).

13. A method for implementing a tensioning device, the method comprising:
providing a mounting plate for mounting on a support (PM) and a tensioning roller centered on a roller axis (X4), the tensioning roller being movably mounted on the mounting plate with at least one degree of rotational freedom around a pivot axis (X6) off-centered relative to the roller axis (X4), wherein the method comprises at least the following successive steps:
providing the tensioning device having at least partially removable indexing means for indexing the position of the tensioning roller relative to the mounting plate in an initial configuration of the tensioning device;
removing a removable member from the tensioning device belonging to the indexing means during a step of preparing of the mounting;
fixedly positioning the mounting plate on the support (PM) during a mounting step;
maintaining manually the removable member in a first orifice belonging to the indexing means and formed in the tensioning roller during a step for preparing the tensioning;
pivoting the tensioning roller about a pivot axis (X6) until the removable member penetrates, through manual action, into a second orifice belonging to the indexing means and formed in the mounting plate during a step for tensioning a traction member; and
locking the rotation of the tensioning roller relative to the mounting plate around the pivot axis (X6) by locking means and keeping under tension (F) the traction member by the tensioning device during a locking step.

14. The method according to claim 13, further comprising a step of removing at least one portion of the removable member outside the tensioning device by breaking, traction or unscrewing.

15. The tensioning device according to claim 4, wherein the second portion is removable relative to the first portion by breaking.

16. The tensioning device according to claim 7, wherein the indexing member is completely removed from the tensioning device by traction or unscrewing.
